(19) United States
(12) Patent Application Publication
(10) Pub. No.: US 2014/0149153 A1
(43) Pub. Date: May 29, 2014

(54) METHOD AND SYSTEM FOR DYNAMIC PARKING ALLOCATION IN URBAN SETTINGS

(71) Applicants: Christos G. Cassandras, Sudbury, MA (US); Yanfeng Geng, Billerica, MA (US)

(72) Inventors: Christos G. Cassandras, Sudbury, MA (US); Yanfeng Geng, Billerica, MA (US)

(21) Appl. No.: 14/129,680

(22) PCT Filed: Jul. 2, 2012
(86) PCT No.: PCT/US2012/045241

§ 371 Date: Dec. 27, 2013

Related U.S. Application Data
(60) Provisional application No. 61/503,786, filed on Jul. 1, 2011.
(60) Provisional application No. 61/521,424, filed on Aug. 9, 2011.

(51) Int. Cl. G08G 1/14; G06Q 10/02

(52) U.S. Cl. CPC G08G 1/14; G06Q 10/02
USPC 705/5

(57) ABSTRACT

A “smart parking” system and method for an urban environment based on a dynamic resource allocation approach. The system assigns and reserves an optimal resource (parking space) for a discrete user based on the user's objective function that combines proximity to destination with parking cost, while also ensuring that the overall parking capacity is efficiently utilized. The solution of each Mixed Integer Linear Program (MILP) is an optimal allocation based on current state information and subject to random events such as new user requests or parking spaces becoming available.

### CROSS-REFERENCE TO RELATED APPLICATIONS

This application claims the benefit of priority of U.S. Provisional Patent Application Nos. 61/503,786 filed on Jul. 1, 2011 and 61/521,424 filed on Aug. 9, 2011.

### STATEMENT REGARDING FEDERALLY SPONSORED RESEARCH OR DEVELOPMENT

The U.S. Government has a paid-up license in this invention and the right, in limited circumstances, to require the patent owner to license others on reasonable terms as provided for by the terms of grant EFRI-0735974 awarded by the National Science Foundation.

### FIELD OF THE INVENTION

A smart parking system is disclosed and, more specifically, a parking system and method for managing parking allocation an urban environment based on a dynamic resource allocation approach.

### BACKGROUND OF THE INVENTION

It is estimated that, on a daily basis, 30% of the vehicles on the road in the downtown area of major cities are cruising in search of a parking spot, which takes an average of 7.8 minutes to locate. This situation is a major waste of time and fuel for the drivers who are looking for parking as well as for other drivers as a result of traffic congestion. For example, it has been reported that over one year in a small Los Angeles business district, cars cruising for parking created the equivalent of 38 trips around the world, burning 47,000 gallons of gasoline and producing 730 tons of carbon dioxide.

Over the past two decades, traffic authorities in many cites have started to inform and guide drivers to parking facilities using real-time information such as the number of available parking spaces. One such parking management example is a parking guidance and information (PGI) system. The PGI system is based on the development of autonomous vehicle detection and dynamic information on parking within controlled areas such as parking lots and parking garages. Monitoring of parking availability and occupancy is typically through the use of sensors placed in the vicinity of parking spaces for vehicle detection and surveillance.

Availability information on parking also can be displayed on variable-message signs (VMS) along major roads and streets and at intersections, or it can be disseminated through the Internet or via AM or FM radio. For example, e-parking is a platform that allows drivers to obtain parking information before or during a trip and to reserve a parking spot via phone or the Internet. Bluetooth technology recognizes each vehicle at entry points, which can trigger automatic reservation checking and parking payment.

Although current parking guidance systems increase the probability of finding vacant parking spots, they have several shortcomings. First, by the time a driver arrives at the parking facility, he/she may not actually find vacant parking spots. In essence, such systems change driver behavior from searching for parking to competing for parking. As more drivers are directed toward the same available parking spot(s) it is possible that not one parking spot is free by the time some drivers arrive, thus forcing re-planning and competition for other parking spots.

Second, even if a driver is successfully guided to a vacant parking spot, the system merely increases the probability of finding a parking spot at the expense of missing an opportunity of finding a better or an optimal parking spot. For example, a driver may pay to park at an off-street parking spot but miss the chance to obtain a nearby, free, on-street parking spot that may better serve his or her purpose.

Third, from the traffic authority point of view, parking space utilization becomes imbalanced as parking spaces for which information is provided are highly utilized, disadvantageously causing higher traffic congestion nearby, while other parking spaces may be routinely left vacant.

In general, guidance systems do not solve the basic parking problem. Indeed, system-wide reductions in travel time and vehicle benefits may be relatively small. Even worse, they may create new and/or heavier traffic congestion in areas where parking spaces are monitored.

Therefore, it would be desirable to provide a system and method for “smart parking” by which drivers who are looking for parking spots transmit a request to a processing device at an allocation center that is structured and arranged to determine an optimal parking spot for each requesting driver during a predetermined allocation (time) period.

It would also be desirable that the allocation center evaluates options and determines the optimal parking spot that satisfies both cost and walking distance constraints. Preferably, this is done dynamically and in real-time so that during subsequent allocation periods, a better parking spot can be identified if it comes available.

### SUMMARY OF THE INVENTION

A system and a method for allocating available parking resources to a multiplicity of users, i.e., drivers, are disclosed. The system and method begin with a user request that is accompanied by at least two user-specified requirements: a constraint (upper bound) on acceptable parking cost and a constraint (upper bound) on a desired walking distance between the parking spot and the user's actual destination.

The system and method include an allocation center that is structured and arranged to collect user requests over a pre-determined period of time and to make therefrom an allocation of the available parking resources at decision points in time, seeking to optimize a combination of driver-specific and system-wide objectives. The allocation center is further adapted to assign and to transmit an assigned parking space to each discrete user in real time.

If a user is satisfied with the assignment, he/she has the choice to reserve that parking spot. Once the user makes a reservation and the reservation is accepted, the user can be automatically charged with a reservation fee and the reserved parking spot can be positively reserved for use by the user at the exclusion of all other possible users. Advantageously, this system explicitly allocates and reserves a discrete parking spot to a discrete user, as opposed to simply guiding him/her to a space that may or may not be available when reached.

On the other hand, if a user is not satisfied with an assignment, e.g., because of limited resources or his/her own overly restrictive parking requirements, or if he/she fails to accept it for any other reason, his/her request must wait until the next decision point. During intervals between allocation decisions made by the allocation center, users with no parking assignment may change their cost or walking-distance requirements sua sponte or may be prompted by the system to change their preference information, to improve the user's chances of an allocation if the system is highly utilized.

Once an allocation and reservation have been made, the dynamic system continues to track availability and driver location to provide users with an opportunity to obtain a better parking spot should one become available before the user reaches the reserved parking spot.

The realization of such a “smart parking” system relies on three main requirements. First, the allocation center collects and stores real-time data on the availability status, i.e., vacant (1) or taken (0), of all parking spots as well as geographic positional data of all users who have made parking requests. As already mentioned, current sensing technologies make monitoring parking spots implementable. Moreover, standard GPS technology provides accurate localization of vehicles. Drivers may report their real-time GPS data to the center via a network, e.g., the Internet, telephone or existing on-board vehicle navigational systems.

The second requirement involves effective wireless communication between vehicles and the allocation center. This is also achievable through existing wireless networks that may be proprietary or part of cellular telephone service providers.

Finally, the allocation center must be able to implement a reservation that guarantees a specific parking spot to a discrete user. This is also achievable through wireless technology interfacing a vehicle with hardware that makes a spot accessible only to the driver who has reserved it. Such hardware includes, without limitation, gates, “folding barriers,” and obstacles that emerge from and retract into the ground under a parking spot and/or a red/green light system that is located at each parking spot. A red light indicates that the parking spot has been reserved and a green light indicates that the parking spot is not reserved. Except for the allocation center, only the user who has reserved the allocated parking spot is able to change a red light to a green light.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views.

FIG. 1 shows a block diagram of an illustrative “smart parking” system in accordance with the present invention;

FIG. 2 shows a queuing model for dynamic resource allocation (DRA) in accordance with the present invention;

FIG. 3 shows a small, business district map used in simulations; and

FIG. 4 shows a flow diagram of a dynamic method of allocating parking resources in accordance with the present invention.

### DETAILED DESCRIPTION OF THE PREFERRED EMBODIMENTS

U.S. Provisional Patent Application Nos. 61/503,786 filed on Jul. 1, 2011 and 61/521,424 filed on Aug. 9, 2011, from which priority is claimed, are incorporated herein in their entirety.

### “Smart Parking” System

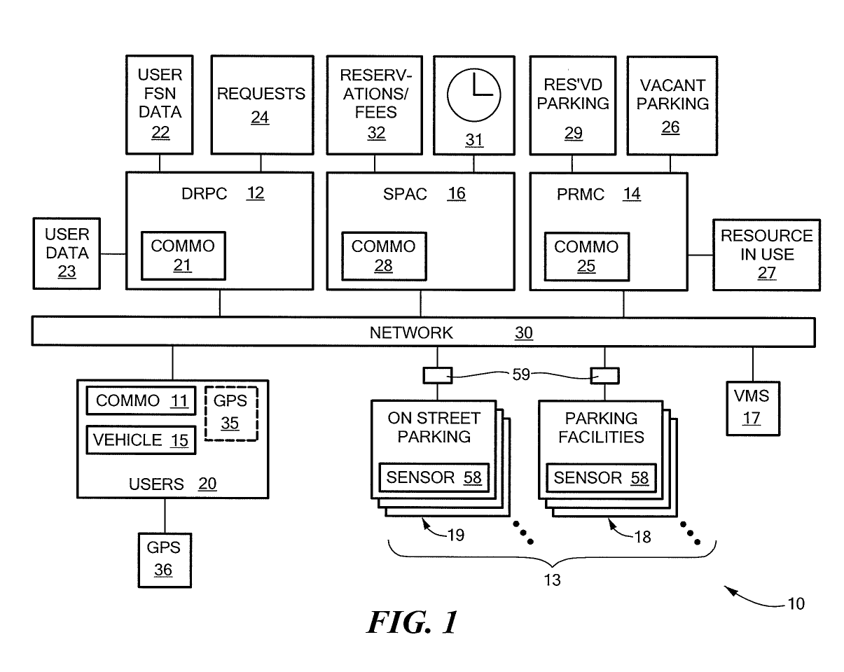

A “smart parking” system will be described referring to FIG. 1. The system 10 includes a Driver Request Processing Center (DRPC) 12, a Parking Resource Management Center (PRMC) 14, and a Smart Parking Allocation Center (SPAC) 16, which are electronically coupled via at least one network 30, e.g., the World Wide Web, the Internet, a wide area network (WAN), a local area network (LAN), and so forth. Preferably, each of the DRPC 12, PRMC 14, and SPAC 16 includes a processing device having a data storage capability, e.g., RAM and ROM, an input/output capability, and a communication capability.

The DRPC 12 is structured and arranged to collect and store parking driver requests and to track in real-time geographic positional data on each user. To that end, the DRPC includes a processing/communication device 21 for communicating with the users 20 and with the SPAC 16; data storage for storing geographic positional data 22; data storage for storing user specific data 23; and data storage for storing user requests/acceptances 24. Although data storages 22, 23, and 24 are described individually, those skilled in the art can appreciate that all the data can be stored in a single memory. Furthermore, although the processing/communicating device 21 is described as a single device, it could be multiple devices that are located near or remote from one another.

The PRMC 14 is structured and arranged to collect and store parking information in real-time and, optionally, to transmit parking data for display on one or more strategically-placed variable-message signs (VMS) 17. To that end, the PRMC 14 includes a processing/communication device 25 for communicating with one or more VMS 17, with a plurality of remote gateways 59 that are structured and arranged to store and maintain local parking information collected from a multiplicity of discrete sensors 58 installed in on-street parking spots 19 and/or off-street parking spots 18, and with the SPAC 16; data storage for storing geographical positional data on vacant parking spots 26 within the urban setting(s) served by the system 10, geographical positional data storage 27 for occupied parking spots within the urban setting(s) served by the system 10, and geographical positional data storage 29 for reserved parking spots within the urban setting(s) served by the system 10. Although data storages 26, 27 and 29 are described individually, those skilled in the art can appreciate that all the data can be stored in a single memory. Furthermore, although the processing/communicating device 25 is described as a single device, it could be multiple devices that are located near or remote from one another.

The SPAC 16 is structured and arranged to dynamically and optimally allocate available parking resources to requesting users 20 during each allocation period. To that end the SPAC 16 includes a processing/communicating device 28 for communicating with the DRPC 12 and the PRMC 14; an allocation period timing device 31; and data storage for storing reservation and reservation fee billing information 32. Furthermore, although the processing/communicating device 28 is described as a single device, it could be multiple devices that are located near or remote from one another and can also include the allocation period timing device 31.

For the sake of generality, the term “user” refers to drivers or vehicles 15 but can also refer to the user's communication device 11, e.g., a processing device, a cellular or mobile telephone, a vehicle-mounted device, and the like, and/or a global positioning system (GPS), which can be a separate device 36 or can be integrated into, e.g., as a GPS application 35, the communication device 11.

### Methodology of Making Optimal Parking Space Allocations

From a control and optimization standpoint, the system and method involve a class of stochastic Dynamic Resource Allocation (DRA) problems. The various stochastic aspects are due to the fact that user requests, i.e., time, geographic location, and resource requirements, the amount of time a parking spot remains vacant, and unknown traffic events during decision intervals are all random, which will affect the allocation results. In addition to standard DRA features, an interesting and unique aspect of the system and method is that reservation/allocation improvements are made dynamically and continuously as the state of the system changes until the reserving user occupies an allocated and accepted resource. Thus, at each decision point during an allocation (time) period, proposed allocations are made for all new requests as well as for current reservations. The latter proposed allocations are further constrained to assignable resources that are as good as or better in terms of the user's objective function.

A key feature of the present invention is that each user 20 has specific parking requirements or preferences that only a subset of all available resources, i.e., parking spots, can optimally satisfy. This is analogous to the Skills-Based Routing (SBR) problem encountered in telephone call centers in which in-coming calls are routed based on the skills required for a server to respond to the call. In contrast, whereas with SBR a server remains assigned to a call until completion, “smart parking” allows resources to be allocated or reallocated so that a user 20 can continuously upgrade the resource assigned to him/her until the allocated, accepted, and reserved parking spot is physically occupied by the reserving user.

With SBR, even without this complicating feature, dynamic routing problems in multi-class, multi-pool call centers are outside the reach of exact analytical methods. Accordingly, the present system and method allocate multiple users to multiple, constantly-changing resources with the further objective of minimizing so-called “abandonment cost” that is incurred when a user's vehicle 15 reaches a final destination before it can be assigned to a feasible parking spot. Hence, the “smart parking” process is a sequence of Mixed Integer Linear Programming (MILP) problems solved over time at specific decision points and, further, subject to suitably designed fairness constraints.

### Dynamic Resource (Parking) Allocation Model

The model assumes that user-specified parking requirements or preferences are prepared by each user 20 in advance but remain changeable by the user 20 at any time. The user-specified requirements include a constraint (upper bound) on acceptable parking cost and a constraint (upper bound) on a desired walking distance between the resource 13 and the user's actual destination. Preference data can be stored in an appropriate memory on the user's communication device 11, e.g., a processing device, a cellular or mobile telephone, a vehicle-mounted device, and the like, and/or can be stored in data storage for storing user specific data 23 in the DRPC 12. Optionally, stored user-specific data 23 can also include a driver's license number, vehicle registration number, vehicle type, vehicle dimensions, and so forth.

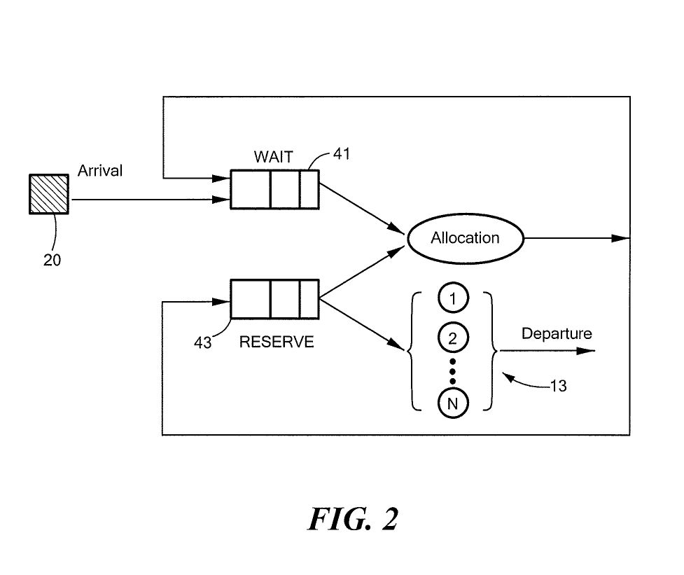

Referring to FIG. 2, a queuing model for dynamic resource allocation (DRA) is shown. The model includes a number of resources 13 (1, 2, . . . N) that are either available (LOGIC 1) or not available (LOGIC 0). Unavailable parking resources are not available because they are presently occupied by a vehicle (LOGIC 0) or other obstruction or they have been allocated and reserved (LOGIC 2). The model assumes that every user 20 arrives, i.e., enters the system, randomly and independently before joining an infinite-capacity queue 41 (labeled “WAIT”), where the user 20 waits for a resource 13 allocation, if possible. At the kth decision point, the system 10 makes allocations for all users 20 in both a first, WAIT queue 41 and a second queue 43 (labeled “RESERVE”) corresponding to users 20 who have already reserved a resource 13 from a prior decision point. If a user 20 in the WAIT queue 41 elects and is successfully assigned a resource 13, the user 20 joins the RESERVE queue 43, otherwise the user 20 remains in the WAIT queue 41. A user 20 leaves the system 10 after occupying a resource 13 for some amount of time, at which point the resource 13 becomes free, vacant or available again. Advantageously, because the system 10 is dynamic, any user 20 who has joined the RESERVE queue 43 may, until the user 20 physically reaches the assigned resource 13 and occupies it, be offered a different, as-good-as or better resource 13 after subsequent decision points.

According to the model, at the kth decision point we can define the state of the allocation system, X(k) as follows:

X(k)={W(k);R(k);P(k)} EQN. (1)

in which W(k)={i: user i is in the WAIT queue}, R(k)={i: user i is in the RESERVE queue}, and P(k)={P(k), . . . , p_{N}(k)} is a set describing the state of the jth resource, j=1, . . . , N, defined as follows:

$${p}_{j} ( k ) = \{ \begin{matrix}- 1 & if resource j is occupied \\ 0 & if resource j is free \\ i & if resource j is reserved by user i\end{matrix} \qquad EQN . ( 2 )$$

Assuming that each resource 13 has a known location associated to it denoted by yⱼ∈Z⊂ [symbol] ² in a two-dimensional Euclidean space, the state of the ith user, Sᵢ(k) can be defined as:

Sᵢ(k)={zᵢ(k),rᵢ(k),qᵢ(k),Ωᵢ(k)} EQN. (3)

in which zᵢ(k)∈Z⊂ [symbol] ² is the location of user i, rᵢ(k)∈ [symbol] ⁺ is the total time that user i has spent in the RESERVE queue 43 up to the kth decision point, i.e., (rᵢ(k)=0 if i∈W(k)), and qᵢ(k) is the reservation status of user i such that

$${q}_{i} ( k ) = \{ \begin{matrix}0 & if i ∈ W ( k ) \\ j & if i ∈ ℜ ( k ) , {p}_{j} ( k ) = i\end{matrix} \qquad EQN . ( 4 )$$

Clearly, if pⱼ(k)=i then qᵢ(k)=j and vice versa.

Finally, Ωᵢ(k) is a feasible resource set for user i, i.e., Ωᵢ(k)⊂{1, . . . ,N} depending on the requirements set forth by this discrete user 20 regarding the resource 13 requested. Preferably, Ωᵢ(k) is a set specified by each user 20 prior to or upon arrival in the system 10. However, for a specific parking problem, Ωᵢ(k) is defined in terms of attributes associated with user i and defined as follows.

At least two attributes based on pre-determined personal preferences are attributed to each user i. The first attribute, denoted by Dᵢ, is an upper bound on the physical distance (measured in feet, yards, meters, and the like) between a resource 13 to which the user 20 could be assigned and the user's actual destination, dᵢ∈Z⊂ [symbol] ². If the user 20 is assigned a resource j located at yⱼ, then Dᵢⱼ=∥dᵢ−yⱼ∥, in which ∥·∥ is a suitable distance metric.

Accordingly, the constraint

Dᵢⱼ≦Dᵢ EQN. (5)

defines a requirement that contributes to the determination of Ωᵢ(k) by limiting the set of feasible, suitable or potential resources 13 to those that satisfy EQN. 5. If the first requirement is expressed in terms of time rather than in distance, then the constraint is simply rewritten as ∥dᵢ−yⱼ∥/V≦Dᵢ, in which V is a given speed parameter, e.g., an average walking speed and the like.

The second attribute for each user i is an upper bound constraint on the cost Mᵢ the user 20 is willing to tolerate for reserving and subsequently using a resource 13. The actual cost depends on the specific pricing scheme adopted by the SPAC 16, which can include, for example, a flat fee for reserving a resource, a fee dependent on the total reservation time, and a fee for occupying the resource 13. Advantageously, this approach does not depend on the specific pricing scheme used; however, it is assumed that each user cost is a monotonically non-decreasing function of the total reservation time rᵢ(k), as well as a function of the traveling time from the user's geographic location at the kth decision time, zᵢ(k) to a resource location yⱼ.

Assuming that sᵢⱼ(k)=∥zᵢ(k)−yⱼ∥ represents this distance and tᵢⱼ(k)=ƒ(sᵢⱼ(k),ω) represents the traveling time, in which ω denotes all random traffic conditions, we can use Mᵢⱼ(rᵢ(k),tᵢⱼ(k)) to denote the total expected cost for using resource j, evaluated at the kth decision time. One should note that Mᵢⱼ(rᵢ(k),tᵢⱼ(k)) is an expectation since the actual cost is a random variable that also depends on traffic conditions, which determine the time tᵢⱼ(k), and on the resource occupancy time, e.g., the actual parking time, after the resource 13 is reached.

Once a pricing scheme is known, the “expectation cost”, Mᵢⱼ(rᵢ(k),tᵢⱼ(k)), can be evaluated assuming that all random variables involved are characterized by known probability distributions. Alternatively, an estimate of Mᵢⱼ(rᵢ(k),tᵢⱼ(k)) can be computed. Furthermore, comparing Mᵢⱼ(rᵢ(k),tᵢⱼ(k)) to Mᵢ, leads to the constraint:

Mᵢⱼ(rᵢ(k),tᵢⱼ(k))≦Mᵢ, EQN. (6)

which defines a second requirement that contributes to the determination of Ωᵢ(k) by limiting the set of feasible, suitable or possible resources 13 only to those resources 13 that satisfy EQN. 6.

In order to fully specify Ωᵢ(k), we further define

Γ(k)={j:pⱼ(k)≠−1,j=1, . . . ,N} EQN. (7)

to be the set of free and reserved resources at the kth decision time and set

Ωᵢ(k)={j:Mᵢⱼ(k)≦Mᵢ,Dᵢ,j∈Γ(k)} EQN. (8)

in which, for simplicity, Mᵢⱼ(k) is used instead of Mᵢⱼ(rᵢ(k),tᵢⱼ(k)). It should be noted that this set allows the system 10 to allocate to user i any resource j∈Ωᵢ(k) that satisfies the user's requirements even if the resource j is currently reserved by another user 20, which is to say that pⱼ(k)=m≠i. Consequently, resource j can be dynamically re-allocated to a different user 20 at each decision point until pⱼ(k)=−1, which connotes that the resource 13 has become physically occupied by a discrete user 20 and is no longer vacant or empty.

Because Mᵢⱼ(k) is generally an estimate of the cost a user 20 may incur, it is subject to noise contributed by random traffic events and, therefore, so is the set Ωᵢ(k) defined in EQN. 7. This implies that a resource j∈Ωᵢ(k) may be such that j∉Ωᵢ(k+1) for some 1>0. Indeed, it is possible that Ωᵢ(k)≠φ such that Ωᵢ(k+1)≠φ. When this occurs, a user 20 may perceive as unfair the fact that he/she is assigned a feasible, suitable or possible resource 13 that ultimately becomes infeasible subject to his/her requirements. As a result, one can assume that this happens as a result of uncontrollable random events, in which case the user 20 must re-enter the allocation system 10 using new Dᵢ and Mᵢ requirement parameters.

Knowing this, one can concentrate on defining an objective function to be minimized at each decision point by allocating resources to discrete users 20. This can be accomplished using a weighted sum to define the cost function of user i, Jᵢⱼ(k) if he is assigned to resource j, as follows:

$${J}_{ij} ( k ) = {λ}_{i} \frac{{M}_{ij} ( k )}{{M}_{i}} + ( 1 - {λ}_{i} ) \frac{{D}_{ij}}{{D}_{i}} \qquad EQN . ( 9 )$$

in which λᵢ∈[0,1] is a weight that reflects the relative importance assigned by the user 20 between cost and resource quality. In the case of parking, resource quality is measured as the walking distance between the parking spot 13 to which the user 20 is assigned and his/her actual destination and/or to the walking time involved in getting from one to the other. Optionally, the degree of difficulty of the walk can be included in an assessment of resource quality. For example, it can be assumed that, while walking to an actual destination, most users 20 would prefer a level or substantially level path rather than one with a steep slope. This is of particular importance to users 20 who may be handicapped or have a low exercise tolerance.

To capture the essence of “smart parking,” the objective of the system 10 is, during each allocation period, to make resource allocations for as many users 20 as possible and, at the same time, to achieve minimum user cost as measured by Jᵢⱼ(k). Defining binary control variables xᵢⱼ as:

$${x}_{ij} = \{ \begin{matrix}0 & if user is not assigned to resource j \\ 1 & if user i is assigned to resource j\end{matrix}$$

one can now define the allocation problem (P) at the kth decision point as follows:

$$\begin{matrix}min {\sum }_{i ∈ W ( k ) ⋃ R ( k )}^{ } {\sum }_{j ∈ {Ω}_{i} ( k )}^{ } {x}_{ij} \cdot {J}_{ij} ( k ) & EQN . ( 10 ) \\ {\sum }_{j ∈ {Ω}_{i} ( k )}^{ } {x}_{ij} = 1 , ∀ i ∈ W ( k ) ⋃ R ( k ) & EQN . ( 11 ) \\ {\sum }_{i ∈ W ( k ) ⋃ R ( k )}^{ } {x}_{ij} \leq 1 , ∀ j ∈ Γ ( k ) & EQN . ( 12 ) \\ {\sum }_{j ∈ {Ω}_{i} ( k )}^{ } {x}_{ij} \cdot {J}_{ij} ( k ) \leq {J}_{{iq}_{i} ( k - 1 )} ( k ) , ∀ i ∈ R ( k ) & EQN . ( 13 ) \\ {x}_{ij} ∈ \{ 0 , 1 \} , ∀ i ∈ W ( k ) ⋃ R ( k ) , j ∈ Γ ( k ) & EQN . ( 14 )\end{matrix}$$

The objective function, hence, focuses on user 20 satisfaction. As a result, one can formulate alternative versions that incorporate system-centric objectives such as maximizing resource utilization or total revenue without affecting the essence of the approach which is primarily dependent on the three constraints in EQNS. 11, 12, and 13. In particular, the “request satisfaction” constraints of EQN. 11 require allocating a resource 13 to every user 20, unless Ωᵢ(k)≠φ.

The capacity constraints of EQN. 12 ensure that each resource 13 is occupied by no more than one user 20. The constraints in EQN. 13 guarantee that every user 20 in the RESERVE queue 43 is assigned a resource 13 that is as good as or better than the resource 13 most recently reserved, i.e., qᵢ(k−1).

The allocation problem (P) is a Mixed-Integer Linear Programming (MILP) problem that can be solved using any of several commercially-available software packages, such as IBM's ILOG CPLEX. However, problem (P) is often infeasible and, as a result, fails to provide an allocation. Infeasibility arises when the number of available resources 13 is smaller than the number of users 20 who are competing for them, violating some of the constraints in EQN. 11. Indeed, for any user subset U(k)⊂{W(k)∪R(k)} let L(k)=[U(k)], in which [·] denotes the cardinality of a set.

If

└Ω₁(k)∪ . . . ∪Ω_{L}(k)┘<L(k) EQN. (15)

for any U(k), problem (P) is infeasible. If that happens, an auxiliary problem may be defined in which the maximum number of users 20 that guarantees that the problem (P) becomes feasible and results in minimal cost must be chosen. In other words, since only constraints in EQN. 11 are violated, one must first find maximal Feasible Subsets (MAX FS) of EQN. 11 and choose one such subset that generates a minimal cost.

However, the problem of finding MAX FS is equivalent to a MIN Irreducible Infeasible Set (IIS) COVER problem, proved to be an NP-hard problem. When the user set is large, determining the MAX FS requires an enormous computational effort and solution time, which are not suited to the real-time nature of such a DRA problem.

### ALLOCATION Feasibility and Fairness

This complication can, nevertheless, be avoided. Observe that the constraints in EQN. 11 apply to users 20 in the set W(k)∪R(k), which requires the system 10 to immediately assign a resource 13 to a new user i∈W(k). This is unnecessarily restrictive given the inherent temporal delay between making a user request and actually occupying a resource 13. Thus, one can replace the constraints in EQN. 11 with the following:

$$\begin{matrix}{\sum }_{j ∈ {Ω}_{i} ( k )}^{ } {x}_{ij} \leq 1 , ∀ i ∈ W ( k ) \\ and & EQN . ( 16 ) \\ {\sum }_{j ∈ {Ω}_{i} ( k )}^{ } {x}_{ij} \leq 1 , ∀ i ∈ R ( k ) & EQN . ( 17 )\end{matrix}$$

and, at the same time, one can include a penalty cost: Σ_{i∈W(k)}(1−Σ_{j∈Ω}_{ᵢ}₍ₖ₎xᵢⱼ) to the objective function in EQN. 10:

$$min {\sum }_{i ∈ W ( k ) ⋃ R ( k )}^{ } {\sum }_{j ∈ {Ω}_{i} ( k )}^{ } {x}_{ij} \cdot {J}_{ij} ( k ) + {\sum }_{i ∈ W ( k )}^{ } ( 1 - {\sum }_{j ∈ {Ω}_{i} ( k )}^{ } {x}_{ij} ) \qquad EQN . ( 18 )$$

It should be noted that, unlike EQN. 11, constraints in EQNs. 16 and 17 are now separately imposed over W(k) and R(k). The constraints in EQN. 16 indicate that any user 20 in the WAIT queue 41 can be assigned—at most—one resource 13; however, a user 20 may also fail to receive an assignment. On the other hand, EQN. 17 guarantees that each user 20 in the RESERVE queue 43 maintains a resource assignment. If the system 10 fails to allocate a resource 13 to a user i, i.e., Σ_{j∈Ω}_{ᵢ}₍ₖ₎xᵢⱼ=0, a cost of 1 is added to the objective function. Therefore, the added term Σ_{i∈W(k)}(1−Σ_{j∈Ω}_{ᵢ}₍ₖ₎xᵢⱼ) is the total cost contributed by the number of “unsatisfied” users 20. Since by its definition in EQN. 9 Jᵢⱼ(k)≦1, the added cost of value 1 is sufficiently large to ensure that a user 20 is assigned to a resource 13 if there are vacant, qualified resources 13 available.

In this formulation, the problem is always feasible. Indeed, letting the matrix X≡└xᵢⱼ┘denote a solution of EQN. 16, then the set

$$\{ X \text{:} {\sum }_{j ∈ {Ω}_{i} ( k )}^{ } {x}_{ij} = 0 , {x}_{{mq}_{m} ( k )} = 1 , i ∈ W ( k ) , m ∈ R ( k ) \} \qquad EQN . ( 19 )$$

is always a feasible solution, since it implies that all users 20 in W(k) are not allocated and all users 20 in R(k) simply maintain their previous reservation (assuming that R(k)≠φ.

As one can see from EQNs. 16 and 17, this strategy provides a higher assignment priority to users 20 in the RESERVE queue 43. This is reasonable because RESERVE queue users 20 have already incurred a positive cost. More particularly, the pricing scheme imposes a fee to assigned users 20 in the RESERVE queue 43 but does not impose a fee on unassigned users 20 in the WAIT queue 41. Although, EQN. 16 does not discriminate among the waiting users 20, regardless of how long they have resided in the WAIT queue 41 or where they are geographically located, this introduces unfairness among waiting users 20.

For example, a first user 20 in the WAIT queue 41 could be located adjacent to a vacant resource 13 that, however, is assigned to a second user 20 who is in the RESERVE queue 43 but who also is at a considerably greater distance from the resource 13. In order to remove such unfairness, the following constraints can be added:

$$[ {\sum }_{n ∈ {Ω}_{i} ( k )}^{ } {x}_{in} ] - {x}_{mj} \geq 0 , ∀ i , j , m s . t . \begin{matrix}j ∈ Γ ( k ) , j ∈ {Ω}_{i} ( k ) , \\ m ∈ W ( k ) , \\ {t}_{mj} > {t}_{ij}\end{matrix} \qquad EQN . ( 20 )$$

These constraints are explained as follows. Consider a resource j that is available for assignment (j∈Γ(k)) and qualified for user (j∈Ωᵢ(k)). If user i fails to be allocated any resource 13, we have Σ_{n∈Ω}_{ᵢ}₍ₖ₎xᵢₙ=0 and EQN. 20 requires that xₘⱼ=0, i.e., any other waiting user m located farther away from resource j than user i, which is to say that tₘⱼ>tᵢⱼ, is barred from being assigned to resource j. If, on the other hand, Σ_{n∈Ω}_{ᵢ}₍ₖ₎xᵢₙ=1 and user i is assigned some resource j, then if xᵢⱼ=1, then xₘⱼ=0, but if xₘⱼ=0, then resource j may or may not be assigned to any other user m≠i, i.e., xₘⱼ≦1.

At this point, a modified problem, which we shall refer to as problem (P), uses the objective function of EQN. 18 and the constraints of EQNs. 11, 12, and 13 from the original formulation, along with EQNs. 16, 17, and 20. Advantageously, the existence of a solution is now guaranteed. However, an important remaining issue concerns the choice of decision points over time, which is to say, defining appropriate “decision intervals” τ(k), k=1, 2, . . . . The simplest idea is to adopt an event-driven approach, i.e., to solve problem (P) whenever an event is observed in the system 10, e.g., a user 20 arrival, a user 20 departure (freeing a resource), a reservation termination (when a user 20 starts occupying a reserved resource), a reservation cancellation (when a user 20 decides to abandon the system 10), some unknown traffic event that may affect estimates of Mᵢⱼ(k), and the like.

The advantage of this approach is that the system 10 provides quick response to users 20; however, it obviously also entails significant computational burden to the system 10 because the frequency of solving problem (P) increases. More disadvantageously is the possibility that a resulting allocation may not be satisfactory. For example, a second user 20 may submit a request into the system 10 but is near a resource 13 that may have already been allocated to a first user 20. However, the resource assigned to the first user 20 may be the second user's 20 only feasible resource 13, while the first user 20 may have had several other acceptable, feasible resource 13 choices. So, instead of resolving the unfairness, the second user 20 is forced to wait.

If the system 10, however, had delayed the decision time until both users 20 have arrived, then both of them can be immediately allocated. This example indicates that the SPAC 16 generally benefits from information accumulated over some time interval in order to generate allocations that are not biased toward earlier-arriving users 20.

The key observation here is that the benefit of a resource 13 to a user 20 is realized when the user 20 ultimately occupies a resource 13. Indeed, the inherent delay incurred by users 20 in the WAIT queue 41 or in the RESERVE queue 43 is not detrimental to them (unlike classical queuing systems) but rather beneficial, since it provides flexibility both to users 20, who can wait until a potentially better resource 13 is available, and to the system 10 that can more efficiently balance the load of its resources 13.

This suggests a time-driven strategy for decision making. Accordingly, after the (k−1)th decision point, the system 10 waits for some duration, τ(k), and then makes new allocations to all users 20 that arrived during τ(k) and all previous users 20 residing in either the WAIT queue 41 or RESERVE queue 43. Clearly this involves a tradeoff as a large τ(k) may eventually yield a lower cost for all users 20 involved, despite forcing a large number of users 20 to remain in the WAIT queue 41 with no assignment, until it is either too late, e.g., because a user 20 has reached his/her destination, or the user 20 has lost patience and searches for resources 13 by himself/herself.

In solving problem (P), it is desirable to minimize user costs as defined by EQN. 9 at each decision point. In order to assess the overall system performance over some time interval [0, T], one can define several appropriate metrics evaluated over a total number of users N_{T} served over this interval, i.e., simulation run length. From the system's point of view, resource utilization is a performance metric that can be divided into two parts: uᵣ(T) is the utilization of resources by reservation, i.e., the fraction of resources that are reserved, and uₚ(T) is the utilization by occupancy, i.e., the fraction of resources 13 that are physically occupied by users 20. From the users' point of view, a satisfaction metric for those users 20 that actually occupy a resource 13 can be defined.

Let P(T) be the set of such users 20 over [0,T]. Returning to EQN. 9, let qᵢ*∈{1, . . . , N} be the resource 13 ultimately assigned to user i∈P(T). We then define

$$\begin{matrix}{J}_{{iq}_{i}^{*}} = {λ}_{i} \frac{{M}_{{iq}_{i}^{*}}}{{M}_{i}} + ( 1 - {λ}_{i} ) \frac{{D}_{{iq}_{i}^{*}}}{{D}_{i}} \\ and & EQN . ( 21 ) \\ \overline{J} ( T ) = {λ}_{i} \frac{1}{\vert P ( T ) \vert} {\sum }_{i ∈ P ( T )}^{ } {J}_{{iq}_{i}^{*}} & EQN . ( 22 )\end{matrix}$$

measuring the average cost of users 20 served. Unlike traditional queuing problems, waiting times are not a measure of user 20 satisfaction, since users 20 do not actually need a resource 13 until they have physically reached it. Instead, another metric used is the abandonment ratio a(T) defined as follows, wherein

A_{W}(k)={i:i∈W(k),∥zᵢ(k)−dᵢ∥<ε} EQN. (23)

be the set of users 20 who reach their destination but who are still in the WAIT queue 41 at the kth decision point, where ε>0 is a small, real number used to indicate that a user 20 is in the immediate vicinity of his/her destination dᵢ. If k_{T} denotes the last decision point within the time interval of temporal length T, we then define

$$a ( T ) = \frac{\vert {A}_{W} ( {k}_{T} ) \vert}{{N}_{T}} \qquad EQN . ( 24 )$$

Finally, optionally the average time-to-park tₚ(T), which corresponds to the time from the instant a user 20 “arrives” in the system 10 to the instant the user 20 physically occupies a parking resource 13 can be included.

### Simulation Results

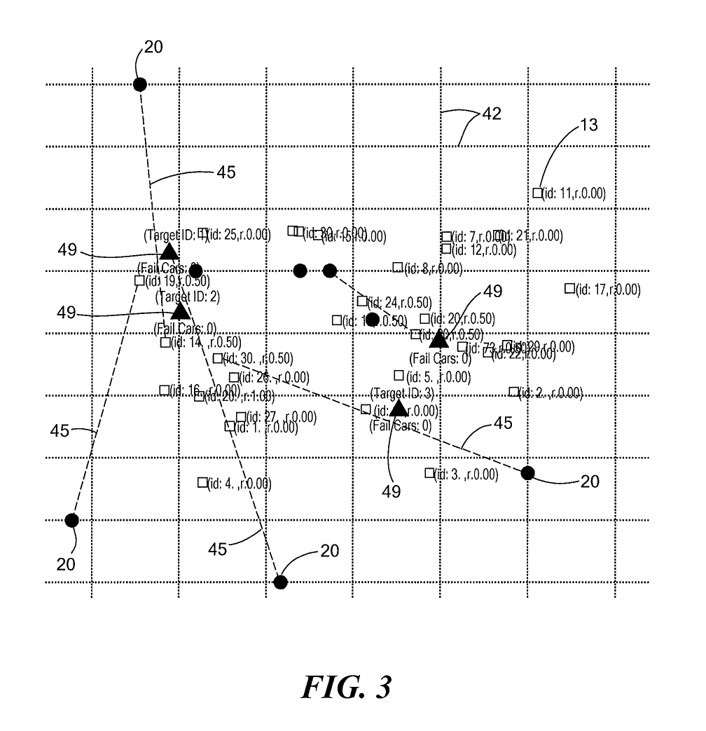

In this section, the results of simulation testing to explore the behavior of the proposed “smart parking” system are presented. A small, business district map is shown in FIG. 3. In this scenario, there are four malls 49 (indicated by triangles), which are the users' destinations, and thirty parking resources 13 (denoted by squares). The lines 42 that define the map grid are roads. Circles represent users 20. A dotted line 45 connecting a user 20 to a resource 13 represents a reservation.

In all simulations, user arrival times are Poisson distributed with rate λ, and uniformly located in the map. The user cost parameter Mᵢ is uniformly distributed in the interval [Mₘᵢₙ, Mₘₐₓ], and the walking-distance parameter Dᵢ is also uniformly distributed in [Dₘᵢₙ, Dₘₐₓ]. The resource occupancy time is exponentially distributed with rate μ.

In the simulations, the adopted pricing scheme, which is based on the expected cost incurred by user i when assigned resource j at the kth decision point, is

Mᵢⱼ(k)=e^{α(r}^{ᵢ}^{(k)+t}^{ᵢⱼ}^{(k))}+CTᵢ EQN. (25)

in which α is a positive constant, rᵢ(k) is the time already spent at the RESERVE queue 43, tᵢⱼ(k) is an estimate of the driving time for user i to reach resource j, and Tᵢ is the expected parking time of user i. Random traffic events in the simulation have not been factored into the simulation. Hence tᵢⱼ(k) is simply estimated by

tᵢⱼ(k)=∥zᵢ(k)−yⱼ∥_{M}/vᵢ EQN. (26)

where ∥·∥_{M} denotes the Manhattan distance from EQN. 18, and vᵢ is user i's estimated average speed. Thus, Mᵢⱼ(k) combines a reservation cost e^{α(r}^{ᵢ}^{(k)+t}^{ᵢⱼ}^{(k))} and actual parking cost CTᵢ. For simplicity, we assume that all resources have the same price parameter C, and there is no flat allocation fee. The former is exponentially increasing with travel time, thus discouraging users from reserving resources while still located far away from them.

The walking-distance cost is defined as Dᵢⱼ=βω_{jdi} in which β is a positive constant and ω_{jdi} is a measure of the walking distance from resource j to user i's destination dᵢ.

In all simulations, a constant decision interval τ(k)=τ, k=1, 2, . . . was used to study the effect of τ on performance metrics. It was expected that as τ increases, a(T) in EQN. 24 should increase because the temporal length of the WAIT queue 41 increases with τ and the number of waiting users 20 that reach their destination before having an opportunity to join the RESERVE queue 43, i.e., |A_{W}(k_{T})| also increases.

To deal with this effect, an Immediate Allocation (IA) policy is required. More particularly, whenever a user i is in a WAIT queue 41 and reaches a physical location zᵢ such that ∥zᵢ−dᵢ∥≦Vᵢτ, the user 20 is placed in an “immediate allocation” queue. If this queue is not empty, then as soon as a resource 13 becomes available, the system 10 immediately prioritizes user i over all other users 20 in W(k) and assigns him/her this available resource 13 if it is feasible. This “immediate allocation” problem is easy to solve.

For example, defining an “urgent” user set as:

I(k)={i:i∈W(k),∥zᵢ−dᵢ∥≦vᵢτ} EQN. (27)

and, as soon as a resource j becomes free, the resource 13 can be allocated to user i such that Jᵢⱼ=min_{n∈I(k),j∈Ω}_{ₙ}₍ₖ₎Jₙⱼ, if such i exists.

TABLE I

| τ | 10 | 15 | 20 | 25 | 30 | E |
|---|---|---|---|---|---|---|
| uₚ(T) | 0.73 | 0.75 | 0.76 | 0.75 | 0.73 | 0.70 |
| uₚ(T)-IA | 0.80 | 0.85 | 0.83 | 0.79 | 0.80 | 0.70 |
| uᵣ(T) | 0.09 | 0.09 | 0.08 | 0.08 | 0.08 | 0.10 |
| uᵣ(T)-IA | 0.09 | 0.07 | 0.09 | 0.08 | 0.08 | 0.10 |
| a(T) | 0.09 | 0.12 | 0.15 | 0.18 | 0.20 | 0.04 |
| a(T)-IA | 0.03 | 0.05 | 0.06 | 0.05 | 0.07 | 0.04 |
| tₚ(T) | 43 | 47 | 51 | 54 | 62 | 40 |
| tₚ(T)-IA | 42 | 43 | 48 | 46 | 50 | 40 |

Table I summarizes results obtained with 1/λ=10 (time units), 1/μ=220; Mₘᵢₙ=Mₘₐₓ=∞, Dₘᵢₙ=Dₘₐₓ=∞. In practice, Mₘₐₓ and Dₘₐₓ are selected as large positive numbers. However, for simulation purposes, there are no constraints imposed by user requirements. Results in Table I are shown for different values of τ, as well as for the event-driven decision policy (labeled E). Every result is generated by the average of five simulations, with each lasting for T=18000. All performance metrics are compared, except for J̅(T) since in this case there are no user requirements.

Also included in Table I are results when the IA policy is adopted. Since requirements are set to infinity, an event-based allocation is very similar to the M/M/n queuing system for which the average utilization is given by ū=λ/(Nμ)≈0.73, which is close to uₚ(T) over different τ values but generally insensitive to τ. It should be noted, however, that uₚ(T)+uᵣ(T) exceeds 0.80; the uᵣ(T) utilization component represents added benefit to the system in terms of revenue, while at the same time providing a reservation guarantee for users.

As expected, the abandonment ratio a(T) decreases with τ and, for sufficiently low values, it is comparable to the event-driven decision policy. The same is true for the average time-to-park tₚ(T) metric.

TABLE II

| τ | 10 | 20 | 30 | E | G | NG |
|---|---|---|---|---|---|---|
| uₚ(T) | 0.73 | 0.75 | 0.72 | 0.70 | | |
| uₚ(T)-IA | 0.76 | 0.84 | 0.75 | 0.70 | 0.75 | 0.72 |
| uᵣ(T) | 0.08 | 0.08 | 0.07 | 0.09 | | |
| uᵣ(T)-IA | 0.09 | 0.08 | 0.07 | 0.09 | | |
| a(T) | 0.23 | 0.29 | 0.33 | 0.25 | | |
| a(T)-IA | 0.19 | 0.23 | 0.19 | 0.25 | 0.35 | 0.55 |
| J(T) | 0.499 | 0.493 | 0.475 | 0.504 | | |
| J(T)-IA | 0.500 | 0.496 | 0.498 | 0.504 | 0.534 | 0.592 |
| tₚ(T) | 58 | 62 | 78 | 48 | | |
| tₚ(T)-IA | 54 | 61 | 74 | 48 | 108 | 180 |

Table II summarizes results that further include user requirements. In these simulations, Mₘᵢₙ=0; Dₘᵢₙ=0; Mₘₐₓ=100; Dₘₐₓ=100; α=0:025; β=1; and C=1. Comparing and contrasting Table II results with those in Table I, although resource utilizations are minimally affected, a(T) considerably increases as the presence of user requirements limits their feasible options. Furthermore, the average user cost J̅(T) decreases as τ increases since the system gathers more user information and is able to make better overall decisions. This also explains why J̅(T) increases when the IA policy is used, though still outperforming the event-driven decision policy.

### “Smart Parking” Method

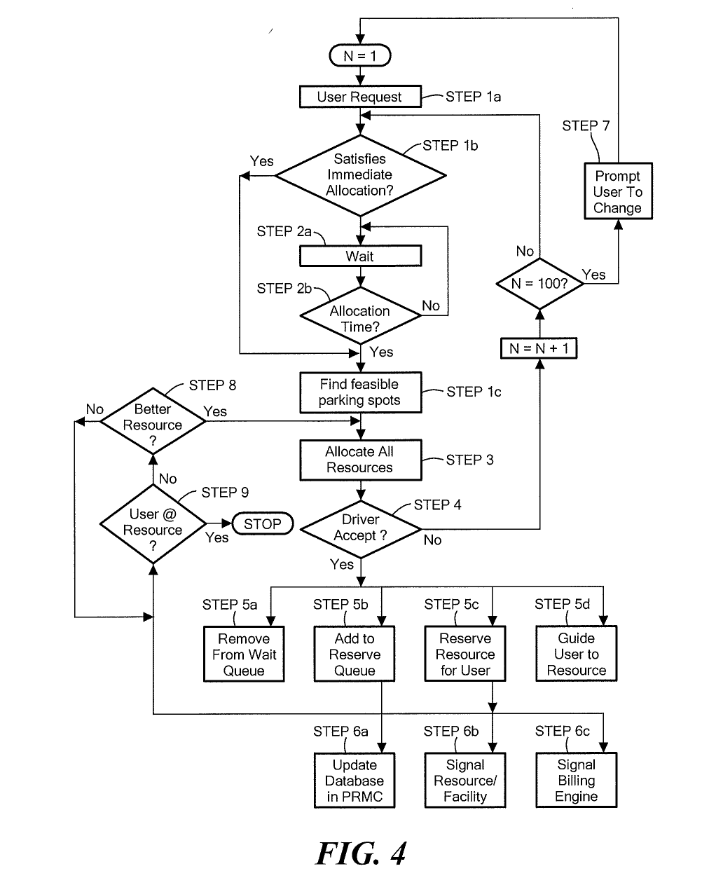

Having described a “smart parking” system and an allocation model strategy for the same, a method of optimally allocating resources and reserving those resources will now be described. FIG. 4 shows a flow chart for allocating parking to a single driver using the system and model described hereinabove.

A user “arrives” in the system by making a request for a feasible and suitable resource (STEP 1a) in the vicinity of an actual destination, e.g., a street address, a landmark, a frequently-visited structure or business, and so forth. The request identifies the user; includes the user's actual destination; provides the user's real-time geographical position, which is provided continuously; and provides geographical position data of the user's actual destination. The identification transmitted can include the user's preferences or requirements as well as other user-specific information, e.g., the user's license, vehicle type, vehicle size, and the like. More preferably, the identification is a pointer to the location of a discrete user file, which is stored in DRPC memory, that contains the preferences or requirements and all or some of the user-specific information. Optionally, the request can also include an estimated parking time, i.e., the time the user expects to occupy the resource.

The DRPC receives the transmitted request(s); stores the request data, e.g., in a WAIT queue; and forwards the request data to the SPAC. If the request (STEP 1a) satisfies all of the conditions for immediate allocation (STEP 1b), the SPAC will find a feasible parking spot (STEP 1c) and allocate it to the user immediately (STEP 3). Otherwise, if the request does not satisfy all of the conditions for immediate allocation (STEP 1b), the user's request waits (STEP 2a) until the next allocation time epoch (STEP 2b) to be allocated. Regardless, users' requests wait (STEP 2a) in the WAIT queue for a next allocation time point (STEP 2b) at which the system checks for feasible parking resources (STEP 1c) for all users and all users' requests.

In order for a request to satisfy all of the conditions for immediate allowance (STEP 1b) several conditions must be met. First, the user's preferences, e.g., cost and walking distance, must be satisfied. Furthermore, the spatial and temporal relationship between the user's real-time geographical position and an available, allocatable parking space must be such that the user would be able to occupy the available, allocatable parking space prior to the next allocation point. For example, if the system determines that a user should arrive at a destination in 60 seconds and the next system allocation decision point is two minutes later, then the system will make an allocation to the user (STEP 3).

The SPAC returns each proposed allocation to the DRPC for transmission to the corresponding user (STEP 3). The user, after receiving the proposed allocation, can accept or reject the proposal (STEP 4). If the user rejects the proposed resource (STEP 4), the DRPC adds the request to the next batch of requests during the next allocation period. If the user accepts the proposed resource (STEP 4), the DRPC signals the SPAC to reserve the resource for the accepting user; deletes the request from the WAIT queue (STEP 5a); and adds the accepted resource to the RESERVE queue (STEP 5b).

After receiving the user's acceptance, the SPAC reserves the resource (STEP 5c) for the discrete user and provides driving directions (STEP 5d) to guide the user to the resource or, alternatively, the user obtains driving directions to his/her allocated parking space via his/her on-board GPS. Reserving the resource (STEP 5c) can include—for the purposes of illustration rather than limitation—signaling the PRMC to update its database(s) on available (vacant) resources, reserved resources, and non-available resources (STEP 6a); to signal the resource or gateway directly and/or to signal the parking facility containing the resource to reserve the resource for the user to the exclusion of all other users (STEP 6b); and to signal a billing engine to charge the user a fee(s) for the reservation (STEP 6c).

Users may change their preferences or requirements at any time, including at any time after submitting a request. For example, during periods of limited resources or because the user's preferences are overly restrictive or if he/she fails to accept an offered resource, he/she will have to wait until the next decision point. During intervals between allocation decisions, users with no parking assignment have the opportunity to change their cost preference or their walking-distance requirements, possibly to increase the chance to be allocated. Because each user establishes his/her own preferences, it is, of course, possible that no parking space is ever assigned to a particular user.

However, if, after a number of unsuccessful allocation periods, no resource has been allocated to a particular user, the SPAC can direct the DRPC to prompt the user to change his/her preferences or requirements (STEP 7). The prompted user may or may not change his/her preferences or requirements. Either way, the request continues to pass through successive allocation cycles until a feasible resource is found, if ever. Although FIG. 4 sets the number of unsuccessful allocation periods at 100, this is done solely for illustrative purposes.

Advantageously, the system and method are dynamic, which means that even though a resource has been reserved for a discrete user (STEP 5c), an as-good-or-better resource may become available (STEP 8) before the user occupies the reserved resource (STEP 9) and, if it does, the SPAC will repeat the allocation process (STEPS 3-6c). The as-good-or-better parking resource may merely benefit the discrete user. For example, a better resource may become available before the user has occupied the reserved resource. The as-good-or-better resource may also benefit more than one user. For example, if the first user's reserved resource is one of multiple alternative feasible resources but is the only feasible resource for a second user, then as a matter of fairness, the resource would be re-allocated to the second user and the first user would receive an as-good-or-better replacement resource.

Once a user occupies his/her reserved resource (STEP 9), the user “leaves” the system; the search for an as-good-or-better resource (STEP 8) terminates; and the PRMC data are appropriately updated.

As previously mentioned, the realization of such a “smart parking” system relies on three main requirements. The third requirement requires that the SPAC implement a reservation that guarantees a specific parking spot to a discrete user. Examples of means for reserving a specific resource for a designated user can include gates, “folding barriers,” and obstacles that emerge from and retract into the ground beneath a parking spot. These hard reservation means can be wirelessly activated. Devices on-board the vehicles, similar to mechanisms for electronic toll systems, can also de-activate the barriers/obstacles to allow the designated user to access the parking spot.

A “softer” reservation means can include, for example, a red/green light system that is integrated into on-street or parking lot parking meters that are disposed at a corresponding parking spot. A red light indicates that the parking spot is reserved and only the user assigned to it is capable of switching the red light back to green. Vehicles parked in a parking spot having a red light can be fined or towed or both. The color of the light can be wirelessly activated by the SPAC via a gateway to designate that the resource is available or not available. The color can also be wirelessly de-activated using on-board vehicle devices, similar to mechanisms for electronic toll systems.

Changes in the details, materials, and arrangement of parts of the system and steps of the method, herein described and illustrated, can be made by those skilled in the art in light of teachings contained hereinabove. Accordingly, it will be understood that the following claims are not to be limited to the embodiments disclosed herein and can include practices other than those specifically described, and are to be interpreted as broadly as allowed under the law.

What is claimed is:

1. A parking allocation and management system for an urban environment for optimally allocating and reserving parking resources for a discrete user based on a user's parking preferences, the system comprising:
a parking resource management center that is adapted to continuously track in real-time a state of occupancy and geographical location of each parking location of a multiplicity of parking locations within the urban environment and to generate state of occupancy data signals and parking resource geographical location data signals;
a driver request processing center that is adapted to continuously receive user requests and user geographical location data and to generate user request data signals and user geographical location data signals; and
a smart parking allocation center that is adapted to receive said state of occupancy data signals, said parking resource geographical location data signals, said user request data signals, and said user geographical location data signals in order to optimally allocate to and reserve parking resources for each discrete user and to dynamically and continuously re-allocate and reserve parking resources until each discrete user has changed the state of occupancy of an allocated and accepted parking resource.

2. The system as recited in claim 1, wherein the driver request processing center includes at least on of:
a processing/communication device for communicating with the user;
a processing/communication device for communicating with the smart parking allocation center;
a database for storing the user's real-time geographical positional data;
a database for storing user parking requests;
a database for storing parking offers made to users;
a database for storing user acceptance of parking offers; and
a database for user parking preference data.

3. The system as recited in claim 1, wherein the parking resource management center includes at least one of:
a processing/communication device that is in communication with and capable of transmitting data signals to a plurality of variable-message signs;
a gateway that is adapted to store and maintain local parking information collected from a plurality of occupancy sensors at on-street parking spots;
a gateway that is adapted to store and maintain local parking information collected from a plurality of occupancy sensors at off-street parking spots;
a database for storing real-time geographical positional data on the on-street and off-street parking spots;
a database for storing real-time geographical positional data on vacant on-street and off-street parking spots;
a database for storing real-time geographical positional data on reserved on-street and off-street parking spots; and
a database for storing real-time geographical positional data on occupied on-street and off-street parking spots.

4. The system as recited in claim 1, wherein the smart parking allocation center includes at least one of:
a processing/communication device that is in communication with and capable of transmitting to and receiving data signals from the parking resource management center and the driver requests processing center;
an allocation period timing device;
a database for storing parking resource reservation data; and
a database for storing reservation fee billing data.

5. The system as recited in claim 1 further comprising a communication device that enables a user to communicate with the smart parking allocation center.

6. The system as recited in claim 5, wherein the communication device includes a database for storing user-specified parking requirements or preferences.

7. The system as recited in claim 6, wherein the user-specified parking requirements or preferences include:
an upper bound constraint on an acceptable parking cost; and
an upper bound constraint on an acceptable walking distance between the allocated parking resource and a user's final destination.

8. The system as recited in claim 4, wherein the allocation period timing device provides a pre-established period of time during which user requests are received; parking resources are allocated; parking resources are reserved; and unfulfilled user requests are placed in a reserve queue if a parking resource has been allocated and reserved for the discrete user or in a wait queue if no parking resource has been allocated.

9. A method of optimally allocating and reserving parking resources in an urban environment for a discrete user based on a user's parking preferences, the method comprising:
receiving a parking request for a parking allocation from at least one user;
continuously receiving geographical positioning data for each of the at least one user;
identifying each of the at least one user's corresponding parking preferences;
receiving continuous parking resource data as to a geographical location and a state of occupancy or vacancy of each parking resource within the urban environment;
optimally allocating parking resources to select users during a first allocation period based on given performance metrics;
reserving an allocated parking resource for a select user after said select user has expressed a desired for the allocated parking resource; and
continuing to optimally allocate comparable or better parking resources to the select user during a second and subsequent allocation periods.

10. The method as recited in claim 9, wherein identifying each of the at least one user and corresponding parking preferences further comprising:
preparing, in advance of receiving a parking request, user-specified parking requirements or preferences for each discrete user; and
modifying the user-specified parking requirements or preferences at any time after initial preparation.

11. The method as recited in claim 10, wherein preparing user-specified parking requirements or preferences for each discrete user includes:
providing an upper bound constraint on an acceptable parking cost; and
providing an upper bound constraint on an acceptable walking distance between the allocated parking resource and a user's final destination.

12. The method as recited in claim 11 further comprising transmitting a message to the user, prompting the user to amend his/her user-specified parking requirements or preferences after a predetermined number of allocations periods.

13. The method as recited in claim 9 further comprising providing driving directions to the select user to the allocated parking resource.

14. The method as recited in claim 9 further comprising:
dynamically re-allocating a reserved but unoccupied parking resource from a first select user to a second select user during a subsequent allocation period; and
allocating another parking resource to the first select user.

15. The method as recited in claim 9, wherein continuing to optimally allocate comparable or better parking resources to the select user during a second and subsequent allocation periods includes:
offering substitute parking resources to select users during a second and subsequent allocation periods; and
reserving an allocated parking resource for said select user after said select user has expressed a desired for the substitute parking resource.

16. The method as recited in claim 9 further comprising placing each user in a reserve queue if a parking resource has been allocated and reserved for the discrete user or in a wait queue if no parking resource has been allocated during any allocation period.

17. The method as recited in claim 14 wherein optimally allocating parking resources to select users includes immediately allocating a parking resource without placing the user in a queue when:
the parking cost of the parking resource is less than the upper bound constraint on parking cost;
the walking distance to the user's final destination is less than the upper bound constraint on an acceptable walking distance; and
the user can occupy the allocated parking resource prior to beginning of the second or subsequent allocation period.
